(19) United States
(12) Patent Application Publication
(10) Pub. No.: US 2013/0130800 A1
(43) Pub. Date: May 23, 2013

(54) WIRELESS CONTROLLER

(71) Applicant: GAMESTOP , INC., Grapevine, TX (US)

(72) Inventors: Karoon Sirilux, Denton, TX (US); Ken Powell, Carrolton, TX (US); Bart de Boisblanc, Arlington, TX (US); Darian James Lockwood, Grapevine, TX (US); Asim Naqvi, Trophy Club, TX (US)

(73) Assignee: GAMESTOP, INC., Grapevine, TX (US)

(21) Appl. No.: 13/657,278

(22) Filed: Oct. 22, 2012

Related U.S. Application Data
(63) Continuation of application No. PCT/US12/61234, filed on Oct. 21, 2012.
(60) Provisional application No. 61/549,828, filed on Oct. 21, 2011.

(51) Int. Cl. A63F 9/24; H04B 7/00

(52) U.S. Cl. 463/37; 455/41.2

(57) ABSTRACT

A wireless controller is configured to communicate wirelessly with a host device, such as a tablet computer. The wireless controller may operate in multiple modes. For example, the wireless controller may operate in a game mode in which it transmits one or more game commands to the host device. The game commands may be transmitted in response to an actuation of a controller input, such as a button or joystick. The wireless controller may be switched from the game mode to another mode, such as a keyboard mode. In the keyboard mode, the controller may translate the controller inputs into keyboard equivalent values that are transmitted to the host device. The wireless controller may be configured to pair with a host device without transmitting a pairing code and without a user entering a pair code.

### CROSS REFERENCE TO RELATED APPLICATIONS

This application claims the benefit of U.S. Provisional Patent Application Ser. No. 61/549,828, filed Oct. 21, 2011 and International Application No. PCT/US12/61234 filed Oct. 21, 2012, the contents of which are hereby incorporated by reference in their entireties.

### BACKGROUND

Wireless controllers often must be paired with a host device, such as a computer, in order to communicate properly. Typically, wireless controllers have buttons and joysticks that enable a user to play games on a video system.

### SUMMARY

A wireless controller is described herein that is configured to communicate with a host device, such as a tablet computer. The wireless controller may operate in multiple modes. For example, the wireless device may operate in a game mode in which it may transmit one or more game commands to the host device. The game commands may be transmitted in response to an actuation of a controller input, such as a button, a joystick, or a combination thereof. The wireless controller may be switched from the game mode to another mode, such as a keyboard mode. For example, when the controller is in a keyboard mode, the controller may translate the controller inputs into alpha-numeric characters that are transmitted to the host device as if transmitted by a keyboard.

Pairing of the wireless controller with a host device may be accomplished via the Bluetooth protocol, but in a manner that does not require entry of a pairing code.

### BRIEF DESCRIPTION OF THE DRAWINGS

FIG. 1 is a top plan view of a wireless controller according to an example embodiment;

FIG. 2 is a perspective view of the wireless controller shown in FIG. 1;

FIG. 3 is a block diagram illustrating functional components of a wireless controller according to an example embodiment;

FIG. 4 shows an example of how the buttons and joysticks on the controller shown in FIGS. 1 and 2 may be translated into keyboard equivalent commands in accordance with an example embodiment;

FIG. 5 is a flow diagram of an example method for pairing a controller to a host device according to an example embodiment; and

FIG. 6 is a block diagram of an exemplary computing system.

### DETAILED DESCRIPTION OF ILLUSTRATIVE EMBODIMENTS

The ensuing detailed description provides exemplary embodiments only and is not intended to limit the scope of the appended claims. Various changes may be made in the function and arrangement of elements and steps without departing from the spirit and scope of the claimed subject matter.

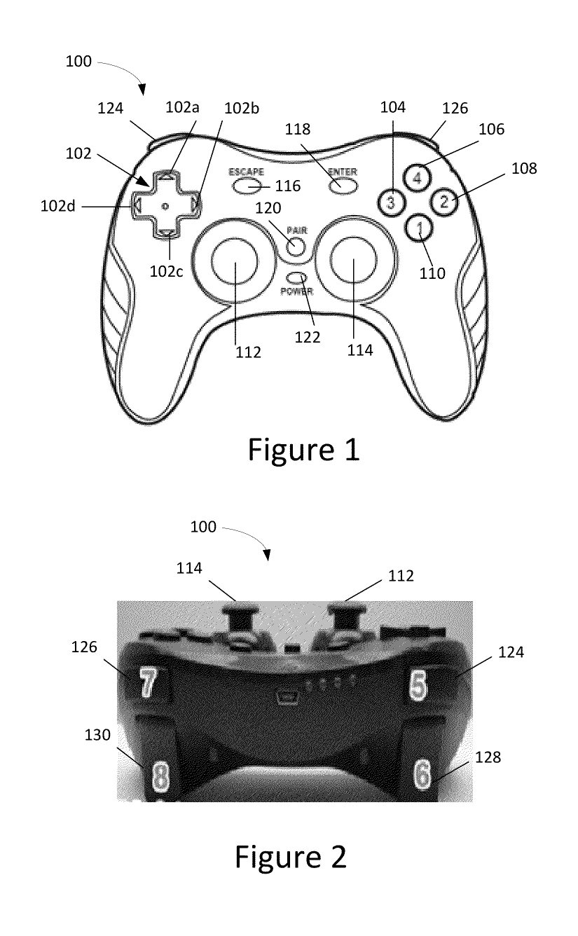

Referring to FIGS. 1 and 2, a wireless controller 100 may allow users to wirelessly communicate with a variety of remote devices such as, for example, computers including tablet computers. For example, the wireless controller 100 may communicate with a desktop or a tablet computer running one of a variety of operating systems. such as Android, iOS, or Windows. The wireless controller 100 may transmit data to remote devices using various protocols such as the Bluetooth protocol or the like. For example, a user may operate the wireless controller 100 to control a game that is loaded on a tablet computer or streamed to a tablet computer.

The wireless controller 100 may provide multiple modes of interaction, each of which may control how the wireless controller 100 interacts with a device. In one embodiment, the wireless controller is configured to operate in at least two modes, one mode comprising a keyboard mode and another mode comprising a game mode. For example, the keyboard mode may allow the wireless controller 100 to communicate with a keyboard interface of a computer device, such as a human interface device (HID) keyboard interface. The keyboard mode may enable users of the wireless controller 100 to assign values and/or commands to controller inputs according to their preferences. Controller inputs (e.g., keypad 102, joysticks 112 and 114, buttons 104-110 and 116-130) may refer to any actuator that can be pressed on the controller or any actuator that can be toggled on the controller, or any combination thereof. For example, a user may operate the wireless controller 100 in the keyboard mode to provide keyboard equivalent inputs to a computer in response to an actuation of a button and/or joystick on the controller.

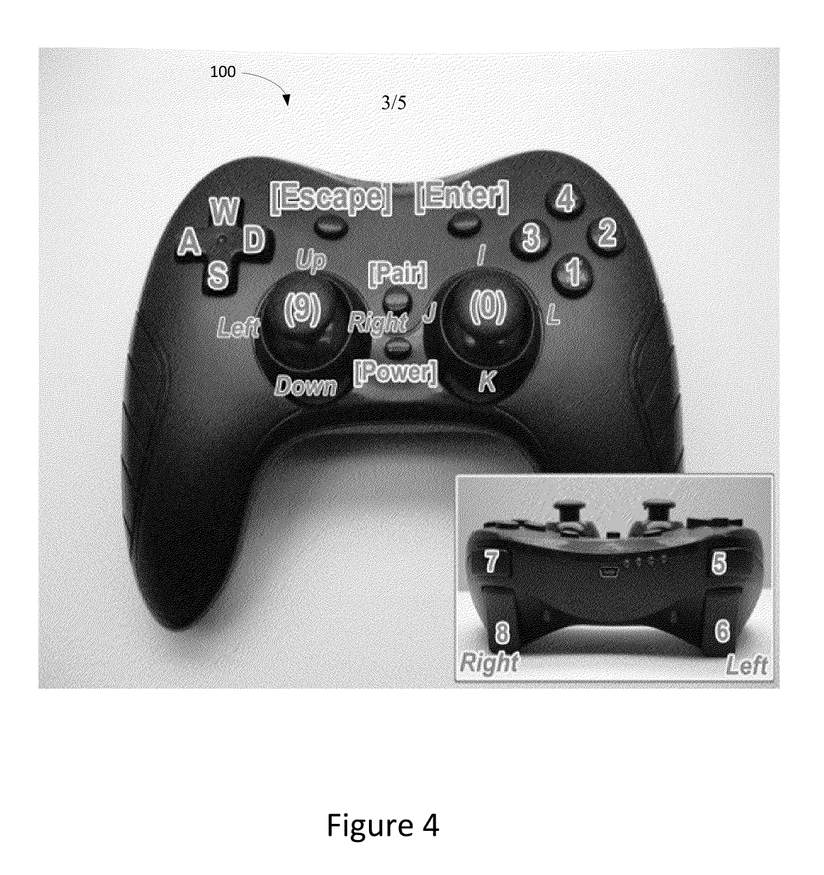

Table 1 represents an example of possible translations between controller inputs (e.g., buttons, keypads, joysticks) and keyboard-equivalent outputs when the controller 100 is in a keyboard mode. For example, the row and column combinations that are shown may result from a specific actuation of a particular button or joystick actuator on the controller 100. For a given row and column combination, a particular keyboard equivalent may be transmitted to the tablet by the controller. FIG. 4 shows keyboard equivalents that are transmitted in response to a specific actuation of each of the different buttons or joysticks on the controller, in accordance with one example embodiment. For example, the actuation associated with column 0 and row 0 may affect a game in the same manner as if the “w” key was pressed on a keyboard. Table 1 presents example keyboard-equivalent outputs, although embodiments are not limited to the illustrated keyboard-equivalent outputs of Table 1.

TABLE 1
GameStop (Gen. 1) Controller Key Matrix

| | ROW 0 | ROW 1 | ROW 2 | ROW 3 | ROW 4 | ROW 5 |
|---|---|---|---|---|---|---|
| COL 0 | W | D | UP | DOWN | 5 | 6 |
| COL 1 | A | S | LEFT | RIGHT | 7 | 8 |
| COL 2 | J | I | 1 | 2 | 9 | 0 |
| COL 3 | K | L | 3 | 4 | ESC | ENT |

In one embodiment, a user may alternate between different modes by selecting a predefined combination of inputs. For example, a predetermined keypad combination, joystick toggle algorithm, or a combination thereof, may alternate the change the mode of the controller 100 from the keypad mode to the game mode, and visa-versa. The game mode may allow users to control a variety of applications, such as a computer game. For example, a user may operate the controller in the game mode to provide commands (e.g., via controller inputs such as buttons, keypads and joysticks) to a computer that is running a game. In the game mode, the controller inputs may be translated into equivalent industry-standard game inputs.

Table 2 illustrates how controller inputs may be translated into game commands in accordance with one embodiment of the game mode. The “Control input key” and “Gamepad Key” columns represent the actual buttons, keypads and joysticks on the controller 100. For example, the “controller input key” column corresponds to the labels shown in FIG. 4. The “Gamepad Hex” and “Gamepad Constant Value” columns show the example translated value for each controller input. The controller may transmit the illustrated translated values to the computer device in response to the respective controller inputs. For example, the translated values may comprise industry-standard values for game controller devices.

TABLE 2

| Control | | | |
|---|---|---|---|
| input | | GAMEPAD | GAMEPAD Constant |
| key | GAMEPAD KEY | HEX | Value |
| 1 | KEYCODE_BUTTON_A | (0x00000060) | 96 |
| 2 | KEYCODE_BUTTON_B | (0x00000061) | 97 |
| 3 | KEYCODE_BUTTON_X | (0x00000063) | 99 |
| 4 | KEYCODE_BUTTON_Y | (0x00000064) | 100 |
| 5 | KEYCODE_BUTTON_L1 | (0x00000066) | 102 |
| 6 | KEYCODE_BUTTON_L2 | (0x00000068) | 104 |
| 7 | KEYCODE_BUTTON_R1 | (0x00000067) | 103 |
| 8 | KEYCODE_BUTTON_R2 | (0x00000069) | 105 |
| 9 | KEYCODE_BUTTON_THUMBL | (0x0000006a) | 106 |
| 0 | KEYCODE_BUTTON_THUMBR | (0x0000006b) | 107 |
| W | KEYCODE_DPAD_UP | (0x00000013) | 19 |
| A | KEYCODE_DPAD_LEFT | (0x00000015) | 21 |
| S | KEYCODE_DPAD_DOWN | (0x00000014) | 20 |
| D | KEYCODE_DPAD_RIGHT | (0x00000016) | 22 |
| UP | | Left Stick | Y_Axis = 1 |
| LEFT | | Left Stick | X_Axis = −1 |
| DOWN | | Left Stick | Y_Axis = −1 |
| RIGHT | | Left Stick | X_Axis = 1 |
| I | | Right Stick | Y_Axis = 1 |
| J | | Right Stick | X_Axis = −1 |
| K | | Right Stick | Y_Axis = −1 |
| L | | Right Stick | X_Axis = 1 |
| ENTER | KEYCODE_BUTTON_START | (0x0000006c) | 108 |
| ESCAPE | KEYCODE_BUTTON_SELECT | (0x0000006d) | 109 |

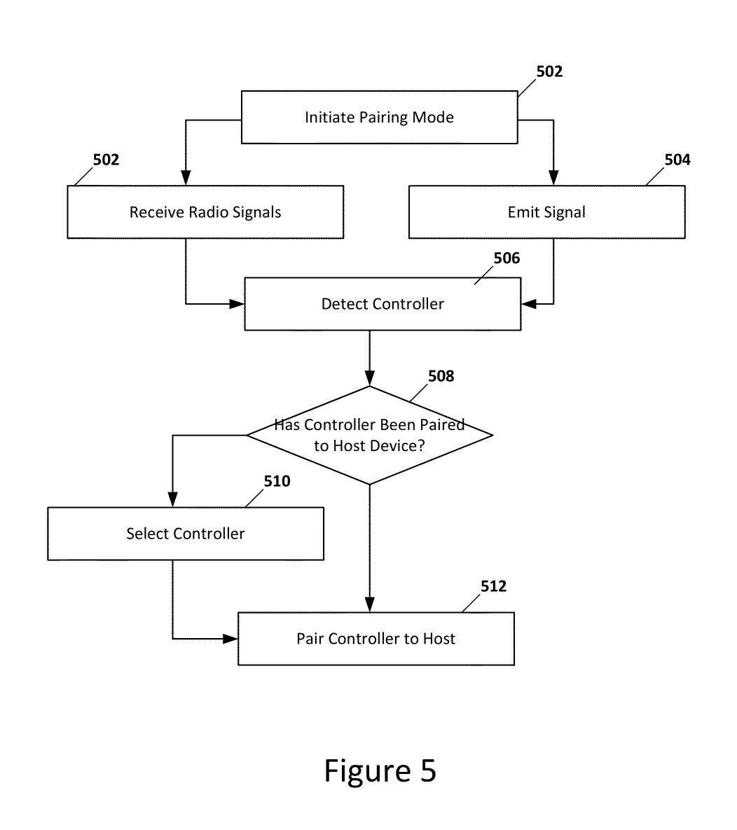

In one embodiment, the wireless controller 100 may pair the controller 100 to a receiving device without entering a security code. Pairing may refer to a device establishing a connection with another device. In an example configuration, the wireless controller does not request authentication, such as by requesting a pass key code, while in the keyboard mode. In such a configuration, the wireless controller 100 may synchronize to a remote device while the wireless controller 100 is in the keyboard mode. For example, referring to FIG. 5, at 502, a pairing mode may be initiated. For example, a user may actuate a pair button 120 on the wireless controller 100. Alternatively, pairing may be initiated by a host device. The pairing mode may enable the wireless controller 100 to be discovered by a host device such as, for example, a tablet computer or the like. For example, at 502, the wireless controller may request a service connection and may receive radio channels from the host device via the service connection. Such a service connection may be established via the Bluetooth protocol or the like. Alternatively, at 504, the controller 100 that is in a pairing mode may emit an electromagnetic signal, an infrared signal, a signal that is transmitted via Wi-Fi, or the like. A host device may search for devices in a detectable range that are configured to be in a discoverable mode. At 506, the host may detect the wireless controller. For example, a host device may detect a signal that is emitted from the controller. After detection, at 508, the host device may identify the wireless controller as a game controller or the like, and may determine whether the host device has previously been paired with the identified controller. If the host device has not been paired to the controller, at 510, a user may select the detected wireless controller for pairing. After selection, the controller may be paired to the host device, at 512, without requiring authentication. Alternatively, if, at 508, the host device determines that the detected controller has previously been paired to the host device, the host device and controller may automatically pair with each other at 512. For example, identifying information of the wireless controller, such as a controller identification number or name, may be stored by the host device after an initial pairing. If the host device has not stored identification information that corresponds to the controller, the host device may determine that it has not previously been paired with the controller. If the host device matches the controller's identification information with identification information that is stored by the host device, the host device may determine that the controller has previously been paired with the host device. Thus, after an initial pairing between the host device and the controller (e.g., during a future connection), the host device may automatically identify the wireless controller and the controller may automatically identify the host device. Whether or not the controller and the host device have previously been paired, the wireless controller is able to pair with a host device at 512 without requiring entry or transmission of a pairing code.

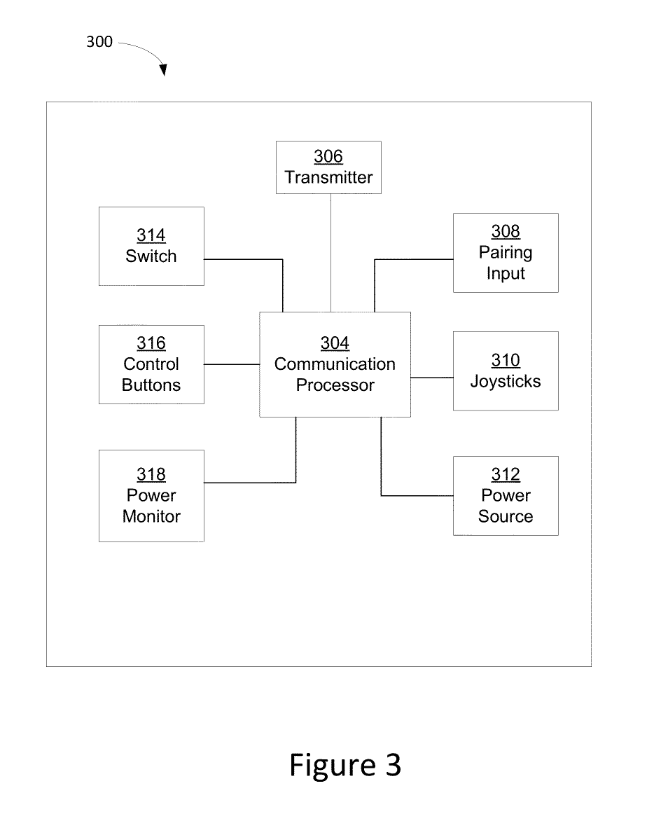

FIG. 3 shows a block diagram of the functional components of a wireless controller 300 according to an example embodiment. As shown in the illustrated embodiment, the wireless controller 300 may comprise a communication processor 304 that is coupled to a transmitter 306, a power switch 314, one or more control buttons 316, one or more joysticks 310, a pairing input 308, a power monitor 318, and a power source 312. The communication processor 304 may translate input values (e.g., via control buttons 316 and joysticks 310) from the controller 300 into key commands (such as alpha-numeric key commands or game commands) that are the transmitted to the receiving device. The translation may be based on the mode selected by a user of the wireless controller. The communication processor 304 may be implemented by a Bluetooth compatible processor. For example, control button inputs may be translated into key codes to provide inputs to an HID controller integrated into a Bluetooth module. The wireless controller 300 may implement translations with hardware, software, firmware or any appropriate combination thereof. Translating the input controller button, keypad and joystick actuations into commands or values, for example, may enable a computer device to receive the desired game commands or keyboard-equivalent values. The communication processor 304, in combination with the pairing input 308 and the transmitter 306, may effectuate the operations necessary to pair a controller with a host device, as described herein.

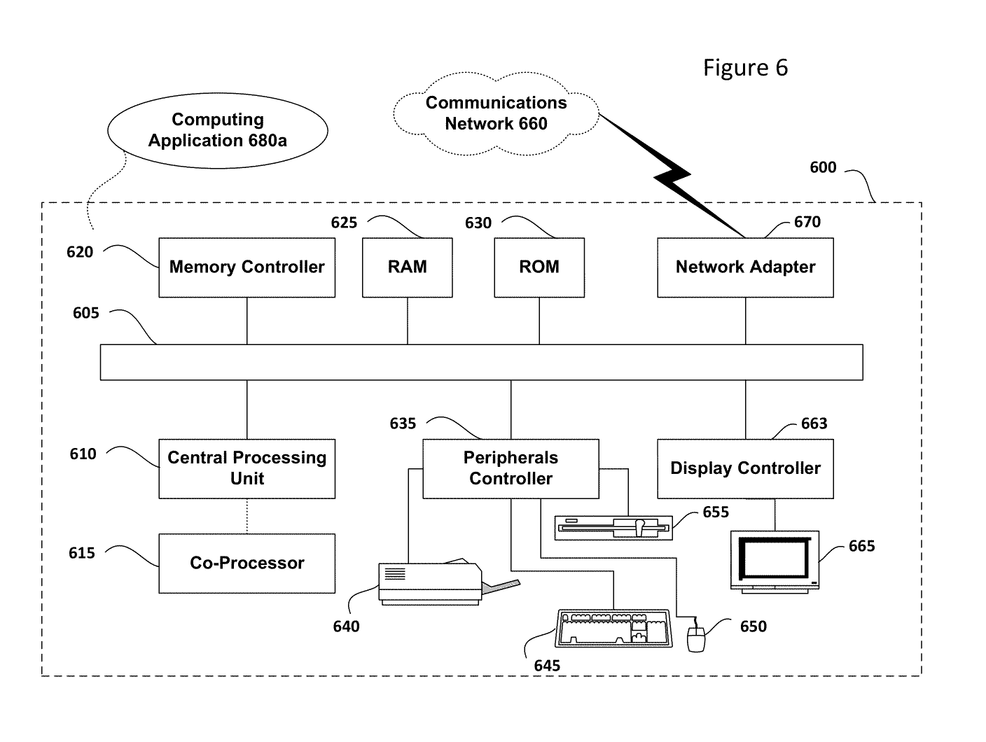

FIG. 6 is a block diagram of an exemplary computing system on which, for example, a host device that is paired with a controller may be implemented. Computing system 600 is controlled primarily by computer readable instructions, which may be in the form of software, wherever, or by whatever means such software is stored or accessed. Such computer readable instructions may be executed within central processing unit (CPU) 610 to cause computing system 600 to do work. In many known workstations and personal computers, central processing unit 610 is implemented by a single-chip CPU called a microprocessor. In other machines, the central processing unit 600 may comprise multiple processors. Coprocessor 615 is an optional processor, distinct from main CPU 610, that performs additional functions or assists CPU 610.

In operation, CPU 610 fetches, decodes, and executes instructions, and transfers information to and from other resources via the computer's main data-transfer path, system bus 605. Such a system bus connects the components in computing system 600 and defines the medium for data exchange. System bus 605 typically includes data lines for sending data, address lines for sending addresses, and control lines for sending interrupts and for operating the system bus. An example of such a system bus 605 is the PCI (Peripheral Component Interconnect) bus.

Memory devices coupled to system bus 605 include random access memory (RAM) 625 and read only memory (ROM) 630. Such memories include circuitry that allows information to be stored and retrieved. ROMs 630 generally contain stored data that cannot easily be modified. Data stored in RAM 625 can be read or changed by CPU 610 or other hardware devices. Access to RAM 625 and/or ROM 630 may be controlled by memory controller 620. Memory controller 620 may provide an address translation function that translates virtual addresses into physical addresses as instructions are executed. Memory controller 620 may also provide a memory protection function that isolates processes within the system and isolates system processes from user processes. Thus, a program running in a first mode can access only memory mapped by its own process virtual address space; it cannot access memory within another process's virtual address space unless memory sharing between the processes has been set up.

In addition, computing system 600 may contain peripherals controller 635 responsible for communicating instructions from CPU 610 to peripherals, such as, printer 660, keyboard 645, mouse 650, and disk drive 655.

Display 665, which is controlled by display controller 663, is used to display visual output generated by computing system 600. Such visual output may include text, graphics, animated graphics, and video. Display 665 may be implemented with a CRT-based video display, an LCD-based flat-panel display, gas plasma-based flat-panel display, or a touch-panel. Display controller 663 includes electronic components required to generate a video signal that is sent to display 665.

Further, computing system 600 may contain network adaptor 670 that may be used to connect computing system 600 to an external communications network 660. Communications network 660 may provide computer users with means of communicating and transferring information electronically. Communications network 660 also may include but is not necessarily limited to fixed-wire local area networks (LANs), wireless LANs, fixed wire wide-area-networks (WANs), wireless WANs, fixed wire extranets, wireless extranets, fixed-wire intranets, wireless intranets, fixed wire and wireless peer-to-peer networks, fixed wire and wireless virtual private networks, the Internet, and the wireless Internet. Additionally, communications network 660 may provide distributed processing, which involves several computers and the sharing of workloads or cooperative efforts in performing a task. It will be appreciated that the network connections shown are exemplary and that other means of establishing a communications link between the computers may be used.

Any or all of the systems, methods and processes of the controller or host device described herein may be embodied in the form of computer executable instructions (e.g., program code) stored on a computer-readable storage medium which instructions, when executed by a machine, such as a computer, perform and/or implement the systems, methods and processes described herein. Computer readable storage media include both volatile and nonvolatile, removable and non-removable media implemented in any method or technology for storage of information. Computer readable storage media include, but are not limited to, RAM, ROM, EEPROM, flash memory or other memory technology, CDROM, digital versatile disks (DVD) or other optical disk storage, magnetic cassettes, magnetic tape, magnetic disk storage or other magnetic storage devices, or any other medium which can be used to store the desired information and which can be accessed by a computer. A computer-readable storage medium, as described herein is an article of manufacture, and thus, not to be construed as a transient signal.

Changes may be made to the above-described embodiments of the invention without departing from the broad inventive concepts thereof. This invention is not limited to the particular embodiments disclosed but is intended to cover all modifications which are in the spirit and scope of the invention as defined by the appended claims.

What is claimed:

1. A method comprising:
transmitting one or more game commands, by a wireless controller in a game mode, to a host device, wherein each game command corresponds to an actuation of a controller input of a plurality of controller inputs;
switching the wireless controller from the game mode to a keyboard mode;
translating, by the wireless controller in the keyboard mode, each of the controller inputs to a corresponding keyboard-equivalent value; and
transmitting one or more of the keyboard-equivalent values, by the wireless controller in the keyboard mode, to the host device.

2. The method of claim 1, the method further comprising:
switching the wireless controller, in response to at least one predetermined actuation of one of the controller inputs, from the keyboard mode to the game mode.

3. The method of claim 1, wherein the switching from the game mode to the keyboard mode is in response to at least one predetermined actuation of one of the controller inputs, the method further comprising:
switching the wireless controller, in response to the predetermined actuation of the one controller input, from the keyboard mode to the game mode.

4. The method of claim 1, wherein the controller inputs comprise at least one of a button and a joystick.

5. A method comprising:
detecting, by a host device, a wireless controller within a detectable range, wherein the wireless controller is in a discover mode;
determining an identification of the wireless controller;
based on the identification of the wireless controller, determining whether the controller has been paired to the host device; and
pairing the controller to the host device without entering or transmitting a pairing code.

6. The method of claim 5, the method further comprising:
if the controller has not been paired to host device, the controller is paired to the host device response to a selection of the controller via the host device.

7. The method of claim 5, the method further comprising:
if the controller has been paired to the host device, the controller is paired to the host device by matching identification information associated with the controller with identification information stored in the host device.

8. The method of claim 5, wherein pairing the controller to the host device comprises pairing the controller to the hose device in accordance with a Bluetooth protocol.

9. A wireless controller configured to transmit messages to a computer, the wireless controller comprising:
one or more controller inputs configured to, in response to corresponding user actuations, send commands to a processor;
a transmitter configured to:
transmit one or more commands to a host device when the controller is in a game mode; and
transmit one or more keyboard-equivalent values to the host device when the controller is in a keyboard mode; and
a processor configured to:
switch the controller between the game mode and the processor mode; and
translate, each of the one or more keyboard-equivalent values to one or more game commands in response to at least one predetermined actuation of at least one predetermined controller input of the one or more controller inputs.

10. The wireless controller of claim 9, the wireless controller further configured to pair with the computer without transmitting a pairing code.

11. The wireless controller of claim 9, wherein the controller inputs comprise at least one button or at least one joystick.

12. The wireless controller of claim 9, the wireless controller further configured to pair with the computer in accordance with a Bluetooth protocol and without a transmission of a pairing code.
